(19) United States
(12) Patent Application Publication
(10) Pub. No.: US 2007/0017135 A1
(43) Pub. Date: Jan. 25, 2007

(54) Education and entertainment kit

(76) Inventor: Rebecca A. Sharp-Mommeut, Ypsilanti, MI (US)

Correspondence Address: Arnold S. Weintraub;The Weintraub Group, P.L.C., Suite 240, 32000 Northwestern Highway, Farmington Hills, MI, 48334, US

(21) Appl. No.: 11/188,270

(22) Filed: Jul. 22, 2005

(51) Int. Cl. G09F 7/02

(52) U.S. Cl. 40/618

(57) ABSTRACT

A kit or system for promoting both education and entertainment includes at least one elongated surface mountable strip which is utilized to removably mount or attach alphabetical, numerical and/or entertainment devices thereon. At least one strip has a first surface for mounting the strip to a wall or similar support and a second or opposite surface to which the devices are removably adhered. Optimally, the second surface is a “Velcro” surface. The Velcro surface may also have embedded therein a plurality of magnets as well as a plurality of snaps for assuring securement of the items to the strips. The alpha-numeric devices are configured such that each letter of the alphabet capital letter having a script or cursive version of that same letter disposed thereon, the main portion of each letter being of a first color and the script portion being of a contrasting color. The numerical devices all be colored as well, but where the minor portion has the numeral spelled out.

### BACKGROUND OF THE INVENTION

1. Field of the Invention

The present invention pertains to educational and entertainment items or devices optimally provided as a kit. More particularly, the present invention pertains to a system containing surface removably mountable education and entertainment items in kit form. Even more particularly, the present invention concerns a kit containing surface mountable alpha-numeric as well as pictorial items for educational and entertainment purposes.

2. Prior Art

As is known to those skilled in the art to which the present invention pertains the need for educational and entertainment devices maintained or provided as a kit for promoting the intellectual growth of individuals is well known and well documented. There exists in the prior art a multitude of items or devices which assist both in entertainment and education involving alpha-numeric as well as pictorial representations. For example, U.S. Pat. No. 4,382,794 teaches numerical building blocks for teaching number identification. U.S. Pat. No. 5,836,588 teaches a game which employs “VELCRO” sport equipment item which is removably attachable to a wall-mounted mural having a Velcro receptor disposed thereon. In U.S. Pat. No. 5,807,196 there is taught a device for teaching tennis which includes, a “VELCRO” type system. U.S. Pat. No. 3,953,030 teaches a similar approach.

Other alpha-numeric educational devices can be found in U.S. Pat. No. 5,957,692, as well as U.S. Pat. No. 5,114,346.

However, it is to be appreciated that the prior art does not teach “large” items which are removably mountable or similar surface and promotes either entertainment, education or both and which may be provided in kit form.

As well detailed hereinafter, the present invention is directed to such improvements.

### SUMMARY OF THE INVENTION

In accordance with the present invention there is provided a system for promoting both education and entertainment which is in kit form. The system comprises at least one and preferably, a plurality of elongated surface mountable strips which cooperate to define means for mounting and which are utilized to removably adhere alpha-numeric and/or entertainment items thereon which are stored in a kit.

The means for mounting, as noted, is at least one elongated strip, having a first wall-engaging surface for mounting the strip to a wall or similar support and a second or opposite surface to which the devices are removably adhered. Optimally, the second surface is a “Velcro” surface. The Velcro surface may also have embedded therein a plurality of magnets as well as a plurality of snaps for assuring securement of the items to the strips.

The devices, which are used conjointly with the strip or, preferably, a plurality of strips, include, for example, alpha-numeric items wherein each letter of the alphabet is a capital letter having a script or cursive version of that same letter disposed thereon and wherein the main portion of each letter is of a first color and the script portion is of a contrasting color. The same arrangement is accorded numerical devices as well.

Each of the alpha-and/or-numeric devices has a visually perceptible first surface with the contrasting color(s) and an opposite or second surface having a Velcro or similar type means for removably mounting which engages the wall mounted strips. Each of the alphabetical and/or numeric devices may further include, on the second or mounting surface thereof, snaps which are complementary to the snaps on the strips to enable the device to be more securely mounted to the strip(s). Similarly, each of the alphabetical or numerical devices may have a magnet of opposite polarity to those of the strip(s) associated therewith. Alternatively, the alphabetic and/or numeric devices may be formed of a suitable magnetically attractable material such as a metal or the like.

It is further contemplated that the system include pictorial items or representations representative of sports figures and/or dolls which include rotatable and/or removable limbs or limb portion(s). Associated with these pictorial representations are, in a first instance, sports equipment such as balls, rackets and the like which may be removably attached to a limb portion.

Also, interchangeable accoutrements, such as dresses, uniforms, and the like may be provided to enable an alteration of the dress of the pictorial representation. These accoutrements are provided with similar “Velcro” complementary attachments to the representation as well as being outfitted with snaps, magnets and the like.

The mounting strips, alpha-numeric items, accoutrements, etc. are optimally packaged as a kit for utilization by both males and females.

For a more complete understanding of the present invention, reference is made to the following detailed description and accompanying drawing. In the drawing like referenced characters refer to like parts throughout the several views in which:

### BRIEF DESCRIPTION OF THE DRAWING

FIG. 1 is a plan view of a mounting strip in accordance with the present invention;

FIG. 2 is a side elevational view taken along the line 2-2 of FIG. 1;

FIG. 3 is a plan view of an alphabetical device in accordance with the present invention;

FIG. 4 is a cross sectional view taken along the line 4-4 of FIG. 3;

FIG. 5 is a plan view of a personality device utilized in accordance with the present invention; and

FIG. 6 is a plan view showing a plurality of mounting strips on a wall.

### DESCRIPTION OF THE PREFERRED EMBODIMENT

Now, and with reference to the drawing there is depicted therein an educational and entertainment system, in accordance with the present invention.

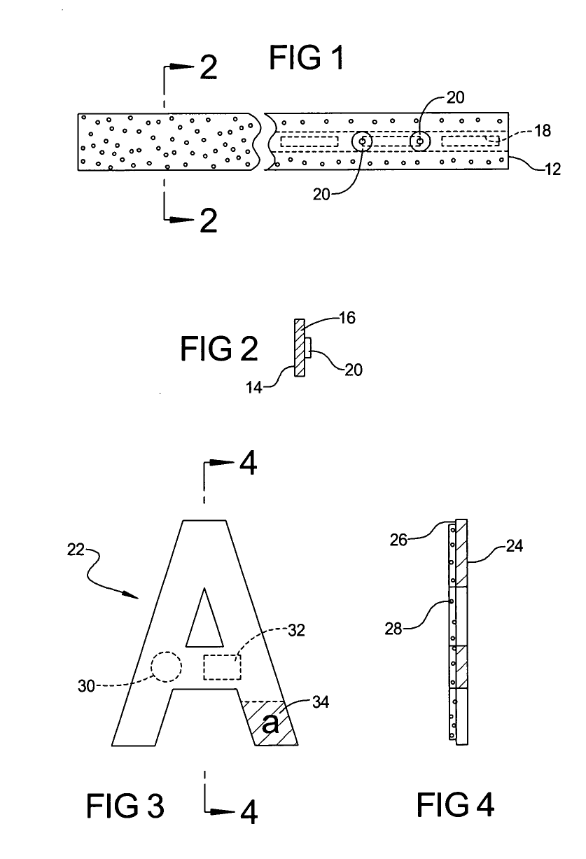

With more particularity, there is shown in FIG. 6 a mounting surface such as a wall 10 upon which is mounted a plurality of the elongated strips 12. Since each strip is constructed the same, only one will be described. As shown in FIG. 1, the strip 12 comprises an elongated member having a visually perceptible first surface or front face 16 and a second or opposite surface—engaging face 14. The face 14 is adapted to enable the strip to be secured to the wall 10 such as with glue, tacks or the like.

The front face 16 is, preferably, formed with or comprises a hook and loop fastener of the type commonly referred to as “Velcro”.

In a preferred form, the strip 12 further has embedded thereon, therein or secured thereto at least one magnetic strip or magnets 18. The magnetic strip 18 can be a rubberized magnet or a plurality of individual magnets such as neodynium magnets or similar magnetic material. The magnets enable the strips to provide further support for the devices or items to be removably mounted thereto.

It is further contemplated that the face 16 has secured thereto a plurality of snaps 20 disposed along the extent thereof. Again, the snaps 20 enable or facilitate the securement of devices thereto.

It should be noted that although the present invention is defined in terms of a plurality of strips 12, the only one of such strip is necessary to define the means for mounting.

Referring again to the drawing and, in particular, FIG. 3, the system or kit hereof further comprises at least one and, preferably, a plurality of alphabetical and/or numerical devices. As shown in FIG. 3 there is an alphabetic items or device shown as the letter “A” and generally denoted at 22. The letter A, as used herein, is only representative of the twenty six alphabetical letters and ten numerals which are contemplated for use herein, namely, the letters A to Z and the numerals 0 to 9. However, for purposes of illustration only the letter A will be described.

The device 22 has a first or front surface 24 and a rear or mounting surface 26. The mounting surface 26 has a Velcro strip or portion 28 secured thereto. The strip or portion 28 is adapted to mate with the Velcro on face 16 formed on the strip 12. Furthermore, the rear surface or mating surface 26 may be further provided with snaps 30 which interconnect with at least an associated snap 20 disposed on the strip 12. Likewise, the device 22 may include at least one and, preferably, a plurality of magnets 32. Where used, each magnet 32 is of opposite polarity, to that used with the strip 12. Alternatively, as noted, the device 22, itself, may be formed from any material suitable for a magnetic attraction such as a thin metal or the like.

The front surface or face 24 of the device 22 is provided with a minor portion 34 in which is inscribed, by any suitable mode, a script or cursive version of the letter represented by the main body of the device 22. From an educational standpoint the main body of the device 22 is provided with a first color of any suitable hue. The portion 34, containing the cursive version of the letter, is provided with a contrasting hue in order to draw attention thereto and to educate the user as to the cursive or script version of the letter represented by the main body.

Where the device 22 is a numeral, although not shown, the comparable minor portion 34 contains the written version of the number represented by the device. In other words, for example, with the number “2” the contrasting portion comparable to portion 34 would have the letters “two” emplaced therewithin.

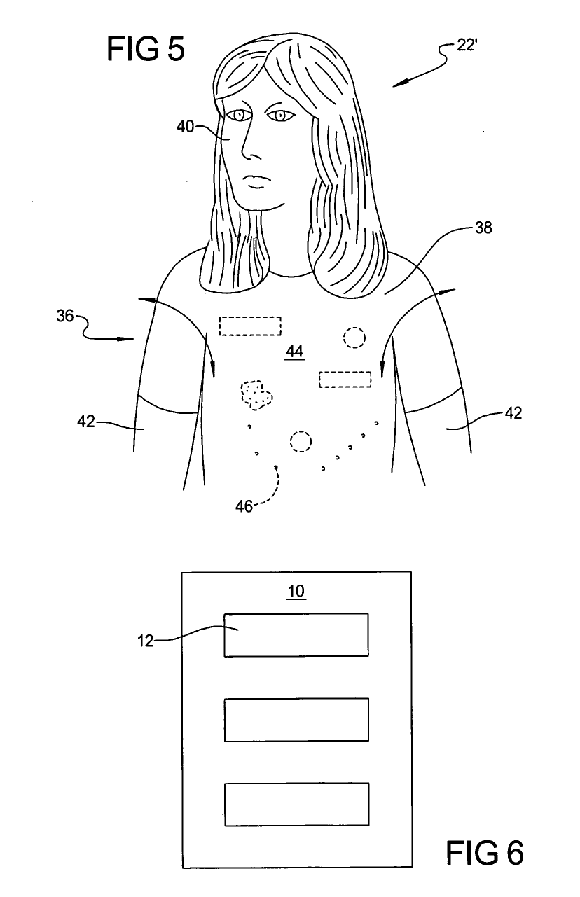

Referring now to FIG. 5 there is a shown a further device 22′, generally denoted at 36 contemplated for use herein. Here, the device 22′ represents a personality or pictorial representation, be it an actual person or a generic person, either male or female, and which is removably mounted to at least one strip and preferably a plurality of strips 12. The device 22′ includes a body portion or torso 38, a head 40, and limbs 42, only the arms being shown. However, it is to be understood that legs may be provided, as desired. Also, the device 22′ may be a two-dimensional representation or a three-dimensional object.

It is contemplated that the limbs 42, themselves, be removable and/or movable. Thus, the limbs are fabricated to have a first forward facing side 44 and a rear surface or side 46 similarly constructed to that of the rear surfaces 26 of the alpha-numeric devices 22. Furthermore, the device 22′, when three-dimensional projects, outwardly from the mounting surface or wall 10. The rear or back side 44 of the device 22′ is provided with suitable meshing Velcro, magnets and/or snaps, as desired. In addition, it is contemplated that the front side 44 of the torso be provided with appropriately placed Velcro portions 46, as well as being capable of having snaps and magnets emplaced thereon. In this manner, outfit changes (not shown) may be removably emplaced on the torso 38. Thus, the outfit changes or accoutrements may be dresses, uniforms, pants, shoes or the like.

With respect to accoutrements such as shoes, they, similarly may be provided with suitable means for removably mounting or adhering including Velcro, snaps as well as magnets or the like.

In practicing the present invention it contemplated that a variety of the items 22 and 22′ be contained within a suitable storage device, such as a box or the like, as well as with the requisite elongated strips 12 to define a kit. Thus, the kit contemplated for use herein would include the strip(s) 12 defining means for mounting to a surface as well as at least one set of devices 22 and/or 22′ be they alphabetical, numerals and/or the personality devices. Optimally, a first kit would contain both the alphabetical and numerical devices and a second kit would contain the personality devices. However, it is within the scope of the present invention that the kit contain a combination of alphabetical, numerical and personality devices including the wall mounted torso or entire form as well as the removable limbs and interchangeable apparel and other accoutrements.

It is also contemplated in the practice of the present invention that with respect to the limbs, that a portion of the limbs be provided with suitable Velcro patches or strips positioned thereon. Here, other accoutrements, such as balls, rackets, and other athletic devices formed from soft materials having suitable Velcro patches thereon could be removably adhered to the limbs of the device 22′. Different apparel accoutrements enable the personality to be changed from a baseball player to a hockey player to a basketball player and, thus, appropriate balls and/or pucks are associated therewith.

With a female personality it is possible to provide removable jewelry such as rings, bracelets, necklaces removably mountable to the head as well as belts for the waist. This is in addition to the shoes as well as changeable apparel such as pants, slacks, skirts, blouses and dresses.

It is apparent from the preceding that there has been described herein an educational and entertainment kit which enables both males and females persons of varying ages to deploy the present invention.

Having thus, described the invention what is claimed is:

1. An education and entertainment system comprising:
(a) means for mounting a plurality of educational or entertainment devices to a surface, and
(b) at least one of a plurality of educational or entertainment devices removably mountable to the means for mounting, the devices being selected from a group consisting of alphabetical devices, numerical devices and personality representative devices.

2. The system of claim 1 wherein each of the removably mountable devices comprises:
(a) a front face,
(b) a rear face, the rear face enabling at least one device to be removably mountable to the means for mounting and
wherein each front face comprises a main body portion of a first hue and minor portion of a second hue, the second hue contrasting with the first hue.

3. The system of claim 2 wherein:
the device is an alphabetical device and further wherein the minor portion has a cursive version of the alphabetical letter inscribed therewithin.

4. The system of claim 2 wherein:
the device is a numerical device, the numerical device being representative of a numeral and wherein the minor portion contains the alphabetical spelling of the numeral represented thereby.

5. The system of claim 1 wherein the means for mounting comprises:
at least one elongated strip having a rear mounting surface for mounting the strip to a support surface and a front surface, the front surface comprising a strip of Velcro, the strip further including at least one snap and at least one magnet disposed thereon.

6. The system of claim 5 wherein each device comprises:
a Velcro portion disposed on the rear face of each device, for removably mounting the device to the means for mounting.

7. The system of claim 6 which further comprises:
at least one snap disposed on the rear face of each device for engaging an associated snap disposed on the means for mounting.

8. The system of claim 7 wherein:
the device is a personality device, the personality device comprising a torso portion, a head portion and a plurality of limbs, the limbs being removably attached to the torso.

9. The system of claim 8 which further comprises:
a mountable accoutrement removably mountable to the torso of the personality device.

10. The system of claim 8 wherein:
the personality device is a three-dimensional body removably mountable to the means for mounting.
